(19) United States
(12) Patent Application Publication
(10) Pub. No.: US 2024/0158674 A1
(43) Pub. Date: May 16, 2024

(54) PRESSURE TUNABLE ADHESIVE SYSTEMS AND METHODS OF MAKING AND USE

(71) Applicant: Purdue Research Foundation, West Lafayette, IN (US)

(72) Inventors: Chelsea Simone Davis, Newark, DE (US); Naomi Deneke, Pearland, TX (US); Edwin P. Chan, Rockville, MD (US)

(21) Appl. No.: 18/505,737

(22) Filed: Nov. 9, 2023

Related U.S. Application Data
(60) Provisional application No. 63/423,982, filed on Nov. 9, 2022.

(51) Int. Cl. C09J 7/38

(52) U.S. Cl. CPC C09J 7/38; C09J 2203/37; C09J 2301/122; C09J 2301/206; C09J 2301/312

(57) ABSTRACT

Pressure tunable adhesive systems and methods for making and using the adhesive systems. Such a pressure tunable adhesive system includes an elastic adhesive substrate and patterns of asperities on a surface of the elastic adhesive substrate. The asperities are microscale and stiffer than the elastic adhesive substrate.

### CROSS-REFERENCE TO RELATED APPLICATIONS

This application claims the benefit of U.S. Provisional Application No. 63/423,982 filed Nov. 9, 2022, the contents of which are incorporated herein by reference.

### STATEMENT REGARDING PRIOR DISCLOSURES BY AN INVENTOR OR JOINT INVENTOR

One or more of the inventors have made disclosures related to the general field of adhesion control via surface topography in the following publications: Deneke et al., Pressure Tunable Adhesion of Rough Elastomers, Soft Matter 2020, 17, 863 (2021).

### BACKGROUND OF THE INVENTION

The present invention generally relates to adhesives. The invention particularly relates to pressure tunable adhesive systems (PTA) formed by polymer thin film dewetting to exhibit an adhesive response that can be varied and preferably tuned with applied pressure during contact formation.

Control of adhesion of a reversible adhesive is important in a host of applications including soft robotics, pick-and-place manufacturing, wearable devices, and transfer printing. While there are adhesive systems with discrete switchability between states of high and low adhesion, achieving continuously variable adhesion strength remains a challenge.

An ideal reversible adhesive relies on the optimization of many performance requirements. A reversible adhesive should be able to adhere to a surface and prevent separation when supporting a specified load. Yet it is also desirable for a reversible adhesive to be easily detached on demand, for example, in pick-and-place applications where sensitive components must be released without damage, or for wearable and medical devices that must be removed from skin without causing pain. Additionally, many of these applications involve adhesion to nonplanar surfaces that span large areas, such that scalability can be another requirement. Conventional pressure sensitive adhesives (PSAs) satisfy the first requirement of adhering to a surface and preventing separation when supporting a specified load. PSAs are capable of sustaining significant loads due to their ability to flow and establish conformal contact without significant applied pressure. While PSAs require a relatively low threshold pressure for contact formation, there is little to no change in their adhesive response if the applied pressure is above this threshold. PSAs are far from ideal as large deformations are required for interfacial separation and, if the adhesive fails cohesively, permanent damage of the interface will limit its reusability and contaminate the target substrate.

Significant advances have been made in the development of adhesive systems. Surface modification, such as patterning with microscopic wrinkles or fibrillar posts, have been demonstrated to enhance adhesion strength or release with some success. These adhesive systems are advantageous as they can be designed with stiffer and more elastic properties relative to PSAs, which can yield switchable or even tunable adhesive systems, which as used herein refers to an adhesive whose adhesive response can be made to vary with applied pressure during contact formation.

Deneke et al., Pressure Tunable Adhesion of Rough Elastomers, Soft Matter 2020, 17, 863 (2021), discloses a generalized approach to obtain a material with pressure tunable adhesion. The approach utilizes a surface patterned material, referred to as a pressure tunable adhesive (PTA) system, employing polymer thin film dewetting. Polymer thin film dewetting is a phenomenon due to an energetically favorable breakdown of a polymer film into droplets due to the application of an external thermodynamic driving force to the film, such as temperature or solvent annealing. Dewetting can occur during thermal annealing of a polymer film above its glass transition temperature (Tg) when there is a mismatch in the surface energies between the polymer film and a substrate supporting the film. The dewetting process generally occurs in the following sequence: nucleation of holes in the polymer film due to thermal undulations, radial growth of these holes, coalescence of holes to form ribbons of polymer, and decay of the polymer ribbons into droplets. The dewetted droplets self-assemble in a characteristic polygonal pattern, and the distance between the nucleated holes ultimately defines the size and spacing of the dewetted droplets, as well as the nearest neighbor distance and the diameter of the polygonal cells. Furthermore, the size and spacing of the droplets increase with increasing distance between the nucleated holes. In general, this distance increases as film thickness increases. The topographical distribution of droplets is further impacted by the dewetting mechanism (i.e., spinodal, thermal, or heterogenous) which is dependent on film thickness. Additionally, the polymer molecular mass can also affect the droplet pattern by increasing kinetics of the dewetting process, which can produce patterns such as fingering instabilities that lead to broadening of the droplet size distribution.

Notwithstanding advancements that have been achieved in developing tunable adhesion systems, such systems have remained limited either by scalability or the inability to be adapted to a diverse range of surface chemistries. A scalable and universal strategy, which enables the modification of any adhesive surface for pressure tunable adhesion and easy release on a variety of surface materials and geometries, has yet to be fully realized.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, pressure tunable adhesive systems and methods for making and using the adhesive system.

According to a nonlimiting aspect of the invention, a pressure tunable adhesive system includes an elastic adhesive substrate and patterns of asperities on a surface of the elastic adhesive substrate. The asperities are microscale and stiffer than the elastic adhesive substrate.

According to another nonlimiting aspect of the invention, a method of forming the pressure tunable adhesive system includes providing the elastic adhesive substrate and forming the patterns of the asperities on the surface of the elastic adhesive substrate.

According to another nonlimiting aspect of the invention, a method of using the pressure tunable adhesive system includes using the pressure tunable adhesive system in a pick-and-place material handling process to pick up and place objects.

Technical aspects of adhesion systems and methods as described above preferably include the capability of achieving pressure tunable adhesion that is scalable and can readily adhere to and release a variety of substrate materials and geometries.

Other aspects and advantages will be appreciated from the following detailed description as well as any drawings.

### BRIEF DESCRIPTION OF THE SEVERAL VIEWS OF THE DRAWING

FIG. 1A schematically represents a perspective view of a surface of a pressure tunable adhesive system produced by applying a polymer (PS) thin film to an elastic (compliant) substrate formed of an adhesive material (PDMS), and then thermally annealing the thin film to yield a pressure tunable adhesive system comprising discrete asperities (droplets) on the substrate. Prior to annealing, the polymer thin film has a thickness, t. After annealing, the geometries of the resulting asperities are characterized by an asperity height, δ, an asperity diameter, d, and a polygonal cell radius, b.

FIG. 1B depicts optical images of five pressure tunable adhesive systems prepared using polymer (PS) thin films applied to elastic adhesive (PDMS) substrates at different thicknesses. The scale bar is 20 μm and applies to all images.

FIG. 1C is a graph plotting droplet (asperity) heights of the five pressure tunable adhesive systems of FIG. 1B as a function of film thickness. The average asperity height increases with film thickness. Error bars represent one standard deviation.

FIG. 1D is a graph plotting fitted distribution curves of droplet (asperity) heights for the five pressure tunable adhesive systems of FIG. 1B. Increasing the film thickness results in larger asperity height averages and an increased distribution in size.

FIG. 2A is a graph plotting load-displacement curves for the pressure tunable adhesive system (v) of FIGS. 1B and 1C having an asperity height (δ) of 1.34 μm, and FIG. 2B is a graph plotting load-displacement curves for the pressure tunable adhesive system (i) of FIGS. 1B and 1C having an asperity height (δ) of 0.31 μm. The curves are plotted for two different levels of maximum compressive load. FIG. 2A contains an inset showing a schematic of an experimental setup for contact adhesion testing that generated the curves of both FIGS. 2A and 2B. A cylindrical probe (radius 0.5 mm) is indented into the adhesive substrate surface while displacement, A, load, P, and contact images are acquired. The curves are offset by an arbitrary displacement value for clarity.

FIGS. 2C and 2D contain images of pressure tunable adhesive system-probe interfaces during contact for, respectively, the pressure tunable adhesive systems (v) and (i) (asperity heights of δ=1.34 μm and δ=0.31 μm, respectively). The scale bar is 200 μm and applies to all images.

FIGS. 3A and 3B are graphs plotting the tensile portion of the load-displacement curve for tests with varying maximum compressive load, performed on in FIG. 3A the pressure tunable adhesive system (i) (δ=0.31 μm) and in FIG. 3B the pressure tunable adhesive system (v) (δ=1.34 μm).

FIG. 3C is a graph plotting pull-off load as a function of preload for the pressure tunable adhesive systems (i) through (v) of FIGS. 1B and 1C. Pressure tunability is achieved over a wider range of compressive preload as asperity height (δ) increases, while the maximum adhesive strength is reduced. Error bars represent one standard deviation and n=3 for each data point.

FIG. 4A contains images of an exemplary sub-contact formation in the interstitial spacing of a cluster of asperities on the pressure tunable adhesive system (v) (δ=1.34 μm). The perimeter of the region is highlighted and contains asperities. The white scale bar is 150 μm and the black scale bar (inset) is 30 μm. The dashed line indicates the lateral location taken for the cross-sectional view presented in FIG. 4C.

FIG. 4B schematically illustrates a perspective view of a pressure tunable adhesive system and probe before and after adhesive contact is formed. The cluster of asperities effectively behaves as a rigid ring, in the center of which a contact forms between the elastic adhesive substrate (PDMS) and probe. The dashed line indicates the lateral location taken for the cross-sectional view presented in FIG. 4C.

FIG. 4C schematically illustrates a cross-section of contact during formation and separation of a pressure tunable adhesive system. Circular labels illustrate the correlation with P values highlighted in FIG. 2A. The insets show experimental contact images of the region highlighted in FIG. 4A during the approach and retraction phases of an adhesion test and have a physical diameter of approximately 100 μm.

FIG. 5A contains a schematic representation of an axisymmetric contact at an individual cluster of asperities of a pressure tunable adhesive system.

FIG. 5B is a graph plotting dimensionless equilibrium stress, σ(b/E*W)^{0.5}, as a function of dimensionless contact radius, a/b, for a pressure tunable adhesive system. Both the adhesive (solid line, Equation 3) and non-adhesive (dashed line, Equation 4) forms are shown. Results for three values of the dimensionless design parameter, δ(E*/Wb)^{0.5}, are presented. In all cases, the dimensionless asperity diameter d/b=0.1. Two exemplary measurements are shown, labeled (1) and (2), assuming a non-adhesive preload.

FIG. 5C is a graph plotting dimensionless adhesive strength, σ_{c}(b/E*W)^{0.5}, as a function of the dimensionless prestress, σₘ(b/E*W)^{0.5}.

FIG. 5D represents a design map that illustrates the reduction in plateau strength and increase in plateau prestress as the dimensionless design parameter, δ(E*/Wb)^{0.5}, increases until there is total loss in adhesion.

FIG. 6 contains schematic images and a graph demonstrating pick-and-place capabilities of a pressure tunable adhesive system. In the images, the pressure tunable adhesive system picks up and deposits a circular disk from three consecutive substrates that have increasingly greater adhesive properties from left to right. Below the images, a graph plots the load during pick-up and deposition of the substrate as a function of time. Tuning of the adhesion strength of the pressure tunable adhesive system enables the disk to be picked up from the intermediate substrate by changing the amount of load applied during contact.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

The following describes pressure tunable adhesive (PTA) systems that can be achieved by polymer thin film dewetting that, in experimental investigations leading to the invention, resulted in the self-assembly of stiff microscale asperities on an elastic (compliant) substrate formed of an adhesive material. The asperities are referred to herein as “stiff” in that they are stiffer (more rigid) than the elastic substrate, and referred to herein as “microscale” in that they have heights above the surface of the substrate of less than 1000 μm, preferably less than 100 μm, and more preferably less than 10 μm. The adhesion strengths of the pressure tunable adhesive systems are demonstrated to increase with the applied compressive preload due to a contact formation mechanism caused by the asperities. Additionally, a contact mechanics model is developed to explain the resulting trends. For the specific pressure tunable adhesive systems investigated, the force required to remove from the adhesive system an object adhered to the adhesive system (pull-off force) was shown to vary with the applied preload used to adhere the object to the adhesive system. In one nonlimiting example, the pull-off force was able to be increased from 0.4 mN to 30 mN by increasing the applied preload from 1 mN to 30 mN. Finally, the applicability of precision control of adhesion strength is demonstrated by utilizing the pressure tunable adhesive system for pick-and-place material handling. Pressure tunable adhesive systems based on self-assembly of asperities is believed to present a scalable and versatile approach that is applicable to a variety of material systems having different mechanical or surface properties.

The investigations generated pressure tunable adhesive systems whose stiff microscale asperities were patterned by spinodal or thermal dewetting of a thin film, where the physics of the process are governed by intermolecular forces and the distance (l) between nucleated holes is proportional to the square of the film thickness (t), l∝t². The polymer thin film dewetting technique is a phenomenon that can be realized in a host of materials. In the investigations, the adhesive properties of a particular but nonlimiting polymer thin film material were evaluated, and the investigations demonstrated the ability to control of the pressure tunable behavior of the material by changing the size of its stiff microscale asperities produced by dewetting thin films of the material. As thin film dewetting can be designed to occur in various materials systems, the ability to generate a patterned adhesive of stiff microscale asperities has the potential for displacing existing surface patterning approaches and creating such asperities over relatively large surface areas.

Nonlimiting embodiments of the invention will now be described in reference to the experimental investigations leading up to the invention.

As noted above, highly tunable, scalable, and versatile pressure tunable adhesive (PTA) systems were achieved based on the self-assembly of stiff microscale asperities (hereinafter sometimes referred to simply as asperities or droplets) on an elastic (compliant) substrate via thin film dewetting. The investigations demonstrated that the adhesion strength of a pressure tunable adhesive system increases with the applied maximum compressive preload due to the unique contact formation mechanism caused by the stiff microscale asperities.

Polystyrene (PS) and polydimethylsiloxane (PDMS) were chosen as, respectively, the polymer thin film material and the adhesive material forming the elastic (compliant) substrate on which the polymer thin film material was applied and dewetted. Though PS and PDMS were chosen for the investigations, the use of other polymer thin film and elastic (compliant) adhesive materials is foreseeable and within the scope of the invention. To fabricate the pressure tunable adhesive systems, PS thin films were dewetted from a silicone elastomer to form stiff asperities arranged in polygonal patterns on the surfaces of PDMS (adhesive) substrates. The sizes of the asperities were controlled by manipulating the thicknesses of the PS thin films. The thin films are prepared by spin coating 0.5 mass %, 0.75 mass %, 1.0 mass %, 1.2 mass %, and 1.5 mass % solutions of PS (molecular mass=105.5 kg mol-1, polydispersity index=1.05 in toluene on a silicon wafer to obtain 20 nm, 30 nm, 38 nm, 48 nm, and 62 nm thick films, respectively. Each film was then transferred onto the surface of a bulk PDMS elastomer (Dow Sylgard 184) using a film transfer method. The bilayer polymer sample was then thermally annealed at 160° C. (above the glass transition temperature of PS) for twenty-four hours. The now mobile PS polymer chains dewetted from the PDMS substrate to minimize surface area, and the resulting droplets arranged into a polygonal pattern that is characteristic of thin film dewetting and were then solidified by quenching to form stiff microscale asperities on the PDMS substrate surfaces. An advantage of controlling the size and spacing of the asperities by adjusting the film thickness was that any adhesive material can be patterned with stiff microscale asperities if the effective interface potential of the film and adhesive is unstable.

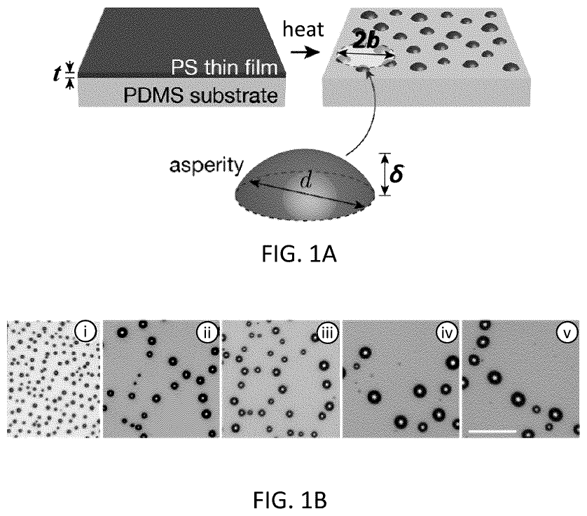

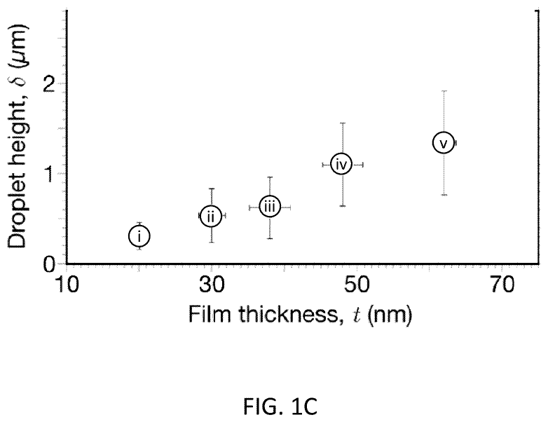

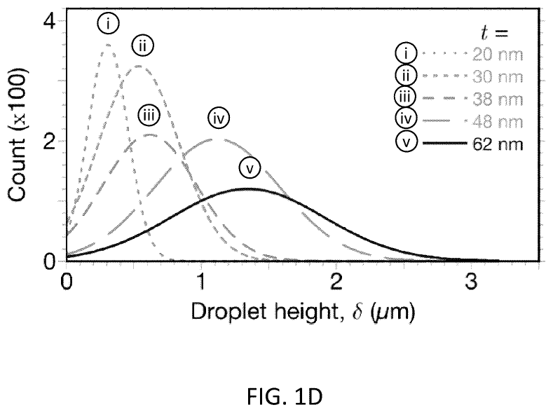

The morphologies of the asperities were characterized. As schematically illustrated in FIG. 1A, the asperities were characterized in terms of asperity height, δ, asperity diameter, d, and polygonal cell radius, b, between adjacent asperities within the same pattern. A total of five PS film thicknesses were prepared and dewetted, which yielded five distinct pressure tunable adhesive systems (identified herein as samples i through v). Representative optical microscopy images for each system are shown in FIG. 1B. As shown in FIG. 1C, increasing the film thickness increased the average asperity height after thermal annealing, with an average asperity height of 0.31 μm, 0.54 μm, 0.62 μm, 1.1 μm, and 1.34 μm for the i through v samples, respectively. As shown in FIG. 1D, while the height distribution of the asperities became broader with increasing film thickness, the average height of the droplet increased with film thickness. The distribution in size for each system was a result of the dynamics of the dewetting process, and although the size of the asperities varied with film thickness, their dimensions remained self-similar. Having demonstrated the ability to control various geometric parameters of the asperities, how these asperities might influence the adhesion of the substrate was investigated.

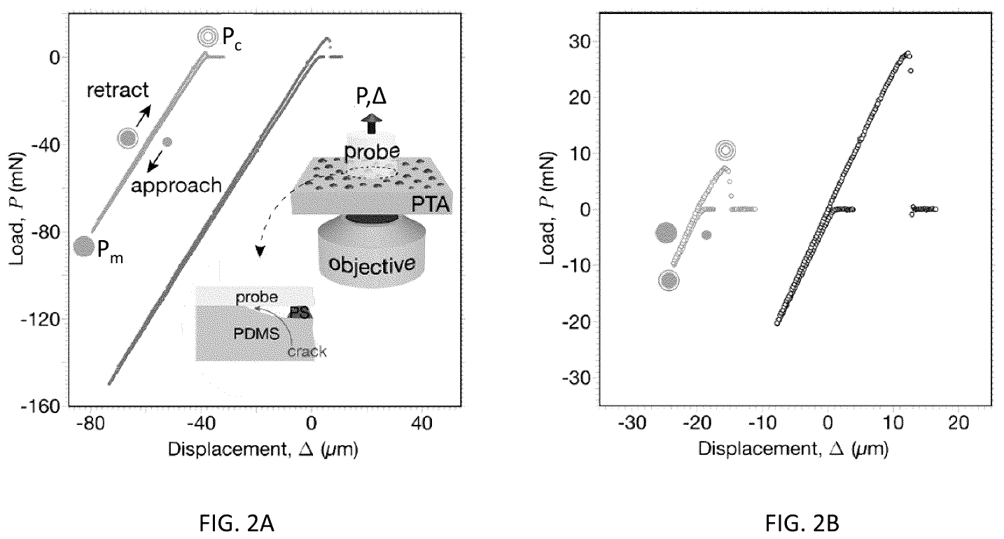

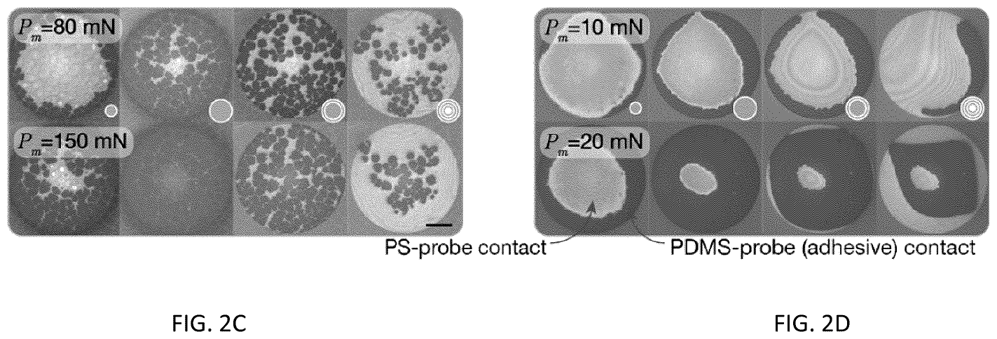

The effects of asperity dimensions on the adhesive performance of pressure tunable adhesive systems were studied using contact adhesion testing. FIG. 2A includes a schematic of a test that involved bringing the flat end of a cylindrical glass probe (radius 0.5 mm) into contact with the pressure tunable adhesive system until a desired maximum compressive load, Pm, was reached. The probe was then retracted from the adhesive until complete separation occurred. The critical pull-off load, Pc, defined as the peak tensile load achieved during retraction, was used as a metric to characterize the adhesive response of each pressure tunable adhesive system. FIGS. 2A-2B are representative adhesion testing results for the pressure tunable adhesive systems i and v, which had the smallest and largest asperities tested (δ=0.31 μm and δ=1.34 μm, respectively). The profiles of the load versus displacement curves were similar between tests except for the location of Pc. This similarity in curve shape was observed across all pressure tunable adhesive systems. For both samples presented in FIGS. 2A and 2B, Pc increased with increasing maximum compressive load, indicating that the adhesive response was pressure dependent. This trend in pressure dependence was consistently observed for all of the tested pressure tunable adhesive systems i through v.

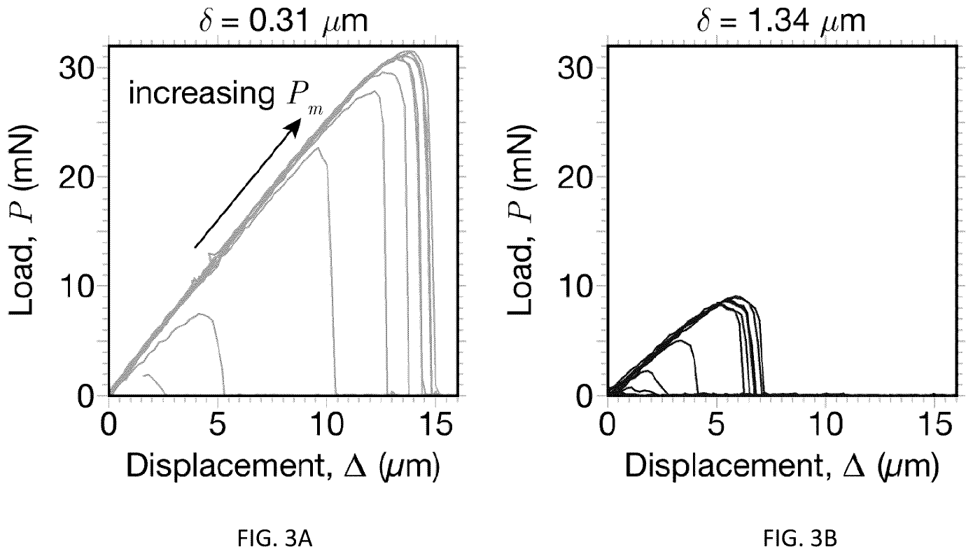

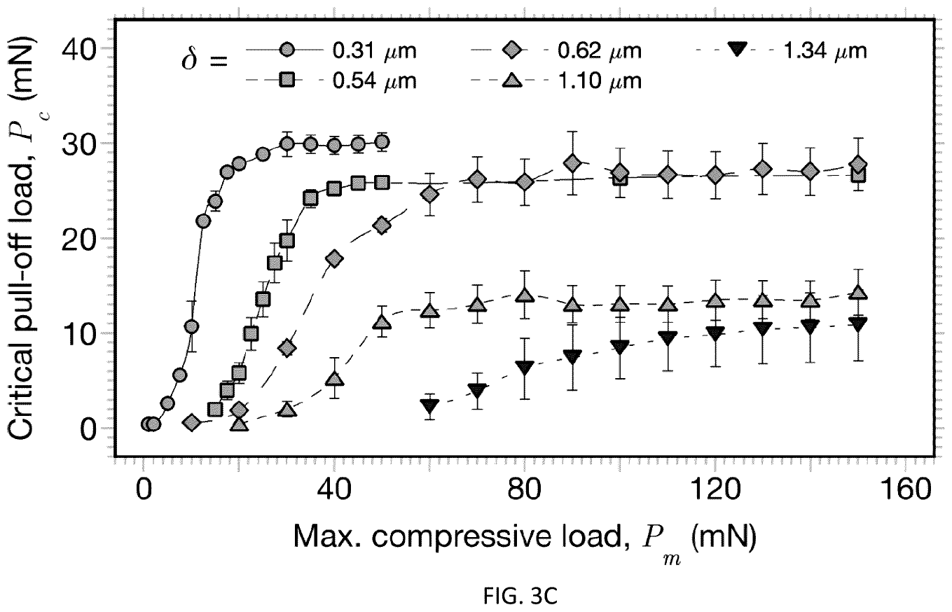

The effect of asperity size was evident by observing how Pc changed as a function of Pm. FIGS. 3A-3B show the tensile portion of the adhesion tests on the smallest and largest asperity pressure tunable adhesive systems (i and v), indented to different Pm values, illustrating that the size of the asperity played an important role in controlling the critical pull-off force. The relationship between asperity size and adhesion can be more clearly resolved when Pc is compared as a function of Pm for all five pressure tunable adhesive systems (FIG. 3C). Each data point is based on an average Pc value for three adhesion tests at a fixed Pm. It was observed that Pc increased with increasing Pm, and that smaller asperities can achieve higher Pc values. It was also found that the pull-off force for those adhesives having smaller asperities was significantly more sensitive to the applied compressive load. As asperity size increased, the strength of the pressure tunable adhesive system was controlled over a broader range of compressive loads. Additionally, Pc values plateaued to a maximum, signifying a point where there was little change in the adhesive response beyond a threshold Pm value. These trends might be explained by studying the global and local contact formation and separation mechanisms, both from contact videos and by performing an analysis of the contact mechanics, the details of which are discussed below.

The enhancement in Pc might be explained by studying the contact formation and separation mechanisms at both macroscopic (across the entire face of the probe) and microscopic (at local sub-contacts) length scales. This analysis was initiated by observing the macroscopic contact. FIGS. 2C and 2D each display a sequence of images of the entire pressure tunable adhesive system-probe interface during contact formation and separation for pressure tunable adhesive systems with large and small asperities. The brightest regions in the images represent the area of non-adhesive contact underneath the probe, and the darkest regions are adhesive contact formation between the probe and elastic and adhesive PDMS substrate. Here, it can be seen that the contact line moved radially inward towards the center of the probe during approach and reached the maximum interfacial contact at Pm. This mechanism of contact formation was attributed to a non-uniform stress distribution in the elastic adhesive substrate during contact. Traditionally, an instantaneous “jump-to-contact” with a probe is observed with non-patterned PDMS due to attractive forces drawing the two surfaces together. However, the presence of the stiff microscale asperities prevented this from occurring, and consequently made contact formation more pressure dependent. It has been documented that the radial pressure profile resulting from the contact of a cylindrical probe and elastic body increases from the center of the contact to the perimeter. This results in adhesive contact formation that initiates from the outer edge of the probe. When the applied preload is increased, the total contact area between the probe and the elastic adhesive substrate increases. This effect was observed when comparing the top rows (low preload) and bottom rows (high preload) of FIGS. 2C and 2D. This larger amount of contact correlated to an increase in adhesion, as quantified by Pc. Consequently, a pressure-dependent adhesive response was observed for all pressure tunable adhesive systems, as presented in FIGS. 3A-3C.

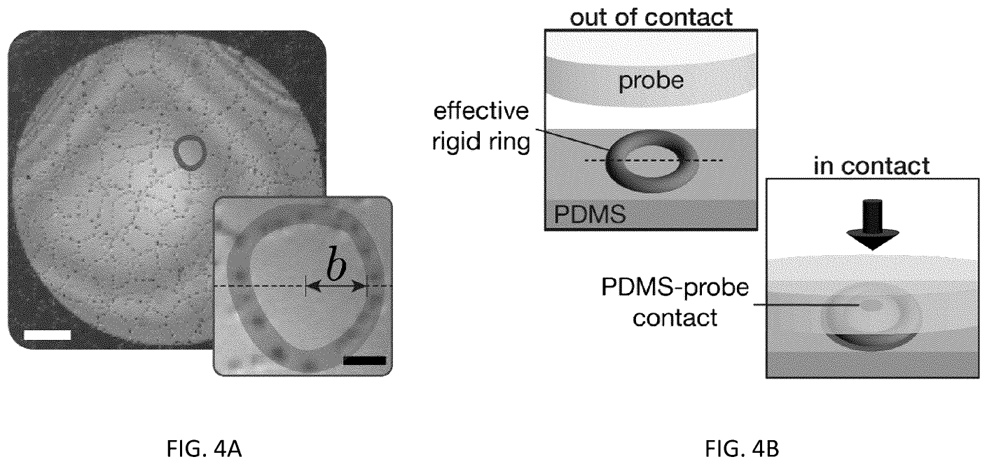

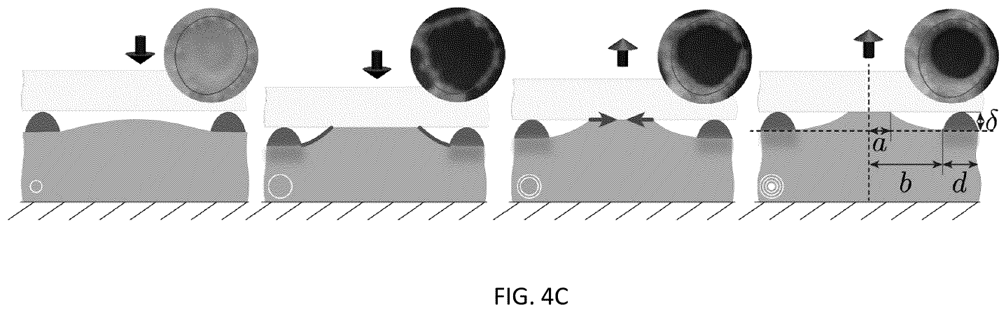

While a macroscopic contact analysis explained the pressure tunability observed in all of the tested pressure tunable adhesive systems (i through v), it did not explain differences in plateau strength and the sensitivity to applied preload between samples, evidenced in FIGS. 3A-3C. This difference was explained by analyzing the contact formation and separation mechanism on the local level, i.e., at a single sub-contact. A sub-contact is considered the contact within a single cluster of asperities, as illustrated in FIG. 4A. Each cluster of asperities, generally in the shape of a polygon or ring whose interior is free of asperities, can effectively behave as a rigid flat-bottomed ring as shown in FIG. 4B, and it is an approximation which was used in an adhesion model. As the applied load increased, adhesive contact was eventually established within the interstitial spacing of the asperities. FIG. 4C illustrates the cross-section of the pressure tunable adhesive system-probe interface along the dashed lines shown in FIGS. 4A and 4B at four stages during contact formation and separation. First, the probe contacted the peaks of the stiff microscale asperities, which led to local indentation of the asperities into the elastic adhesive substrate on which the asperities were formed. Next, at a threshold stress, the local deformation displaced the stiff microscale asperities sufficiently, such that the probe was able to interact with the elastic adhesive substrate and form an adhesive contact of radius, a. Therefore, adhesive contact formation was dependent on the applied load, as well as the density and geometry of the asperities. A larger compressive load was needed to displace larger or more closely spaced asperities into the substrate. Furthermore, increased local deformation of the substrate by the stiff microscale asperities resulted in more stored elastic strain energy that can aid in interfacial separation. Hence, pressure tunable adhesive systems with larger asperities had a lower adhesion response.

As the probe was retracted, a was reduced until complete separation occurred. Changes in the contact area can alternatively be viewed as the propagation of an annular crack which forms around the ring of the asperities (as schematically represented in FIG. 4B and outlined in FIG. 4C). The size of the crack and the stress state at the crack tip is dependent on the applied load, the substrate stiffness, and the asperity size. When the adhesive failure was visualized during adhesion testing (FIG. 2C), crack propagation was initially localized at the perimeter of polygonal cells across the interface for the pressure tunable adhesive systems with larger asperities, whereas global failure occurred along the perimeter of the probe for pressure tunable adhesive systems with smaller asperities. This difference suggested that there is an interplay between global stresses across the interface that arises due to external loading by the probe and local stresses at each cluster of asperities that are dependent upon the asperity size and spacing.

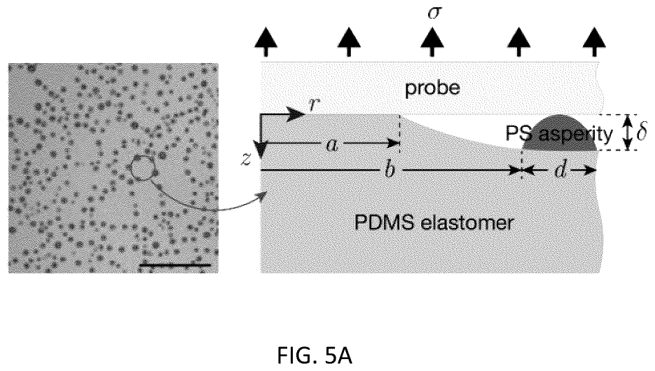

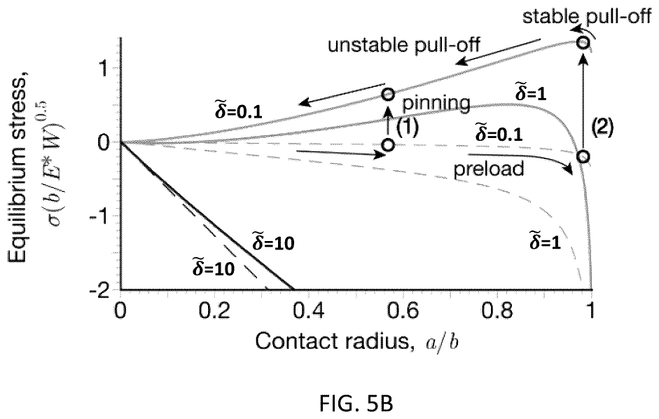

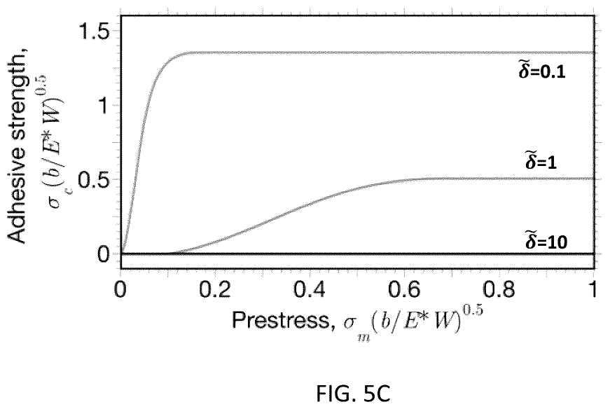

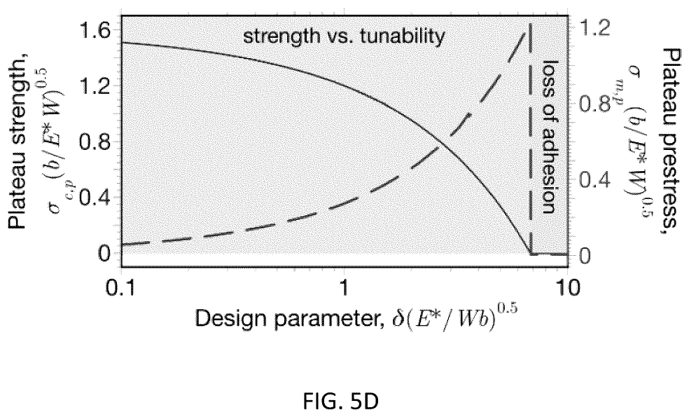

To promote an understanding of the adhesive response as a function of the geometric parameters that can be controlled in pressure tunable adhesive systems, an adhesion model was constructed based on linear elastic fracture mechanics. Having observed that contact between the probe and elastic adhesive substrate occurred within rings of asperities, the model was focused on understanding the local behavior of a single sub-contact as schematically depicted in FIG. 5A. As represented in FIG. 5A, the shape of the asperity was assumed to have a spherical upper surface, whereas the shape of the interface between the asperity and substrate was assumed to be flat. For simplicity, the contact formed between the probe and the substrate was assumed to be axisymmetric, the contact area of this local contact was defined by radius a, and the perimeter of a single sub-contact was a rigid ring of inner radius b. It was assumed that a crack is always present such that a is always smaller than b, a<b. The width and height of this ring are equivalent to the asperity diameter d, and height, δ, respectively. The elastic adhesive substrate was treated as an elastic half-space, and the contact with the probe was assumed to be frictionless. The circumference of the contacting region behaved as the tip of an annular crack. This crack was effectively loaded by the opening displacement imposed by the asperity height. It was also loaded by the remote stress, σ, applied to the contact by the probe.

Under this set of assumptions, the stress intensity factor (K₁) at the crack tip can be obtained by the superposition of existing solutions for the two loading conditions. If the interface between the asperity and elastic adhesive substrate was ideally flat and the asperity was rigid, as assumed, then it would impose a uniform normal displacement on the substrate when indented. Since no closed-form analytical solution exists for this elasticity problem, and since the true shape of this interface was unknown, the assumption of a uniform pressure distribution exerted on the surface of the elastic and adhesive PDMS substrate under the asperity was made. A closed-form solution is available for this problem leading to the stress intensity factor

$${K}_{I} = \frac{σπ {b}^{2}}{2 a \sqrt{π a}} + \frac{δ {E}^{*}}{\sqrt{π a}} f ( \frac{a}{b} , \frac{d}{b} ) \qquad ( 1 )$$

where the plane strain modulus is E*=E/(1−ν2). The function ƒ describes a dimensionless quantity that is geometry dependent. The critical value of the stress intensity factor where interfacial separation occurs is related to the energy requirement of this separation, the work of adhesion W, via the Irwin relationship

K_{c}=\sqrt{2E*W} (2)

Combining Equation 1 and Equation 2, the equilibrium stress was obtained as

$$σ \sqrt{\frac{b}{{E}^{*} W}} = \sqrt{\frac{8}{π} {( \frac{a}{b} )}^{3}} - \frac{2}{π} ( δ \sqrt{\frac{{E}^{*}}{W b}} ) \frac{a}{b} f ( \frac{a}{b} , \frac{d}{b} ) \qquad ( 3 )$$

where the parameters are arranged as dimensionless groups. It is also useful to consider the equilibrium stress when the interface is non-adhesive (W=0). In terms of the same dimensionless groups, the result is

$$σ \sqrt{\frac{b}{{E}^{*} W}} = - \frac{2}{π} ( δ \sqrt{\frac{{E}^{*}}{W b}} ) \frac{a}{b} f ( \frac{a}{b} , \frac{d}{b} ) \qquad ( 4 )$$

FIG. 5B shows the results of both Equation 3 and Equation 4, for multiple values of the dimensionless parameter, \tilde{δ}=β(E*/b)^{0.5}. \tilde{δ} was considered to be the design parameter since the characteristic height (δ) of the asperities, radius (b) of a cluster of asperities, elastic modulus (E*) of the substrate, and work of adhesion (W), could be separately controlled in the experimental design. In all cases presented in FIG. 5A, the dimensionless asperity diameter \tilde{d}=d/b=0.1. Examining the smallest value of the design parameter (\tilde{δ}=0.1), representing small asperities spaced far apart on an elastic (compliant) substrate and with a strong adhesive interaction, only compressive (negative) equilibrium stresses in the non-adhesive case were observed (line in FIG. 5B, Equation 4). The contact radius grew as the magnitude of this compressive stress increased. In the adhesive case (solid line in FIG. 5B, Equation 3), tensile (positive) equilibrium stresses are possible. A maximum in the tensile stress was observed at an intermediate value of the contact radius. As the design parameter was increased to \tilde{δ}=1, representing larger asperities with smaller spacing on a less compliant substrate and weaker adhesive interaction, a larger magnitude of compressive stress was required to form the contact. In the adhesive case, tensile equilibrium stresses were observed over a smaller range of contact radii, and with a lower maximum stress. Eventually, in the case of \tilde{δ}=10, tensile equilibrium stresses were no longer observed. This result suggested that the surface had lost the capability to bear load despite adhesive interaction being present.

The insights gained from the predictions of the model revealed the source of the preload dependence and plateau of the adhesive strength in the pressure tunable adhesive system, which was consistent with the experimental results shown in FIG. 3. Interfacial interactions typically exhibit hysteresis, meaning that the distance over which surfaces jump out of plane to form a contact is much smaller than the corresponding displacement required to achieve separation. Under the assumption, the approach and subsequent contact formation can be treated as non-adhesive, an approach previously utilized when considering preload dependence in the presence of contact curvature. For this reason, during approach one can move along the non-adhesive stress curve until a specified compressive prestress is reached. FIG. 5B shows two representative cases with different magnitudes of prestress. In case (1), the contact grows to a specific radius that is a function of the prestress. As the surfaces are then retracted, the contact line becomes pinned due to the presence of adhesion. As the applied stress becomes tensile, the contact only changes size once the equilibrium adhesive stress is reached. At this point, since the equilibrium adhesive stress is reduced with decreasing contact radius, the pull-off strength (defined as the maximum tensile stress observed during approach and retraction) is observed at the point the contact begins to shrink. If the compressive prestress is increased further, the pull-off strength will grow. This continues until the tensile equilibrium adhesive stress attains its maximum value. Case (2) illustrates the behavior beyond this point, at increasingly larger compressive prestresses. At the point of pinning, a reduction in the contact radius requires an increase in the tensile stress. This leads to a regime where the crack propagates in a stable manner until the maximum tensile stress is attained, at which point separation once again becomes unstable.

FIG. 5C shows the dimensionless pull-off strength as a function of the prestress (also in dimensionless form). The same values of the dimensionless design parameter are considered here. The plateau in FIG. 5C emphasizes that prestressing beyond the point of the maximum tensile stress (as in case (2) of FIG. 5B) does not increase the resulting pull-off strength. As the dimensionless design parameter is increased to \tilde{δ}=1, the plateau occurs at a higher prestress and with a lower pull-off strength. In the case of \tilde{δ}=10, the pull-off strength is zero for any prestress. This provided an explanation for the behavior observed in the experimental results of FIG. 3, where the pull-off force plateaus to lower values as the asperity size was increased and with a more gradual transition to the plateau value.

The relationship in FIG. 5C also illustrates that there was a trade-off in performance for pressure tunable adhesive systems as the asperity design parameter was varied. A more gradual transition to the plateau strength enhanced the tunability of the adhesive system, as less precision over the prestress was required but coincided with a lower plateau strength indicating reduced load bearing capability. FIG. 5C illustrates this by comparing the predictions of the dimensionless plateau strength and plateau prestress versus the asperity design parameter, \tilde{δ}. Generally, larger asperities with smaller spacing, less compliant adhesive substrates, or weaker adhesive interactions have reduced ultimate adhesive strength but a greater tunability with respect to the compressive load applied during contact formation.

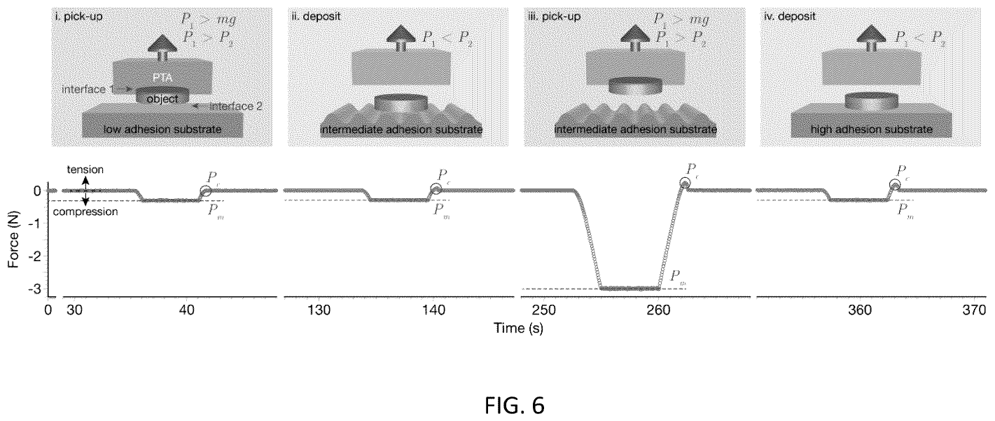

To demonstrate the potential of the pressure tunable adhesive system for real-world applications, such as pick-and-place material handling, the pressure tunable adhesive system was applied as a device for the transfer of a cylindrical object between multiple surfaces with different interfacial properties (FIG. 6). Substrate surfaces with increasing adhesion strengths (glass, wrinkled PDMS, and smooth PDMS) were sequentially arranged in the experiment. Varying values of the compressive load, Pm, were applied during pick-up and deposition of the disk, and the adhesive strengths of the pressure tunable adhesive system-object interface and object-substrate interface were characterized as Pl and P2, respectively (FIG. 6). The object was picked up from the low adhesion substrate (glass) by the pressure tunable adhesive system using a moderate preload that results in Pl>P2. The cylinder was then deposited onto the next substrate (wrinkled PDMS) using the same preload due to intermediate adhesion between the object and substrate that was greater than the adhesion between the object and pressure tunable adhesive system, hence P2>Pl. The object was then picked up from the same substrate with a larger preload, indicating that Pl>P2. Finally, the object was deposited onto the final substrate (smooth PDMS) using the same moderate preload due to high adhesion between the object and substrate and Pl>P2. For a given pressure tunable adhesive system, adhesion strength was controlled by careful selection of the preload (or prestress), most notably during deposition and pick-up from the intermediate adhesion substrate.

In summary, the investigations described above evidenced a pressure tunable adhesive system that can achieve a range of adhesive responses. A key to the pressure tunable response is the formation of patterns of self-assembled stiff microscale asperities on an elastic (compliant) adhesive substrate. The adhesion experiments showed that the pull-off force increased as the amount of compressive preload was increased before plateauing. The adhesion model revealed the source of this plateau in strength to be adhesion hysteresis during approach and retraction steps. The model also illustrated that surfaces with smaller, more broadly spaced asperities exhibited a higher adhesive strength but with reduced pressure tunability, which is in agreement with the experimental results.

As demonstrated, the pressure tunable adhesive system has the potential to be used for pick-and-place material handling applications. Although there are numerous surface patterning approaches, the advantage of thin film dewetting is that it is scalable, as well as adaptable to a wide variety of materials and surface planarities, thus making it amenable to a wide variety of applications. This can be further exploited by changing the mechanical or surface properties of the elastic adhesive substrate and stiff microscale asperities to achieve new pressure tunable adhesion properties for more tailored control or specific engineering requirements. For instance, to enable a more robust pressure tunable adhesive system that can be cleaned and re-usable, instead of using a polymer thin film, one can use a photocurable methylmethacrylate formulation that will undergo autophobic dewetting to form droplets on the surface of an elastic adhesive substrate. The droplets can then be subsequently photocrosslinked to form a semi-interpenetrated network with the substrate to enhance interfacial strength between the droplets and the substrate and prevent dissolution of the droplets when the interface needs to be cleaned with a solvent.

As previously noted above, though the foregoing detailed description describes certain aspects of one or more particular embodiments of the invention and investigations associated with the invention, alternatives could be adopted by one skilled in the art. For example, asperities could differ in appearance from the embodiments described herein and shown in the drawings, process parameters such as temperatures and durations could be modified, and appropriate materials could be substituted for those noted. As such, and again as was previously noted, it should be understood that the invention is not necessarily limited to any particular embodiment described herein or illustrated in the drawings.

1. A pressure tunable adhesive system comprising:
an elastic adhesive substrate; and
patterns of asperities on a surface of the elastic adhesive substrate, the asperities being microscale and stiffer than the elastic adhesive substrate.

2. The pressure tunable adhesive system of claim 1, wherein the pressure tunable adhesive system is operable such that a force required to remove an object from the pressure tunable adhesive system is varied by varying an applied preload used to adhere the object to the pressure tunable adhesive system.

3. The pressure tunable adhesive system of claim 1, wherein the asperities have heights above the surface of the elastic adhesive substrate of less than 10 μm.

4. The pressure tunable adhesive system of claim 1, wherein the asperities have heights above the surface of the elastic adhesive substrate of about 0.31 μm to about 1.34 μm.

5. The pressure tunable adhesive system of claim 1, wherein the patterns of the asperities comprise clusters of the asperities.

6. The pressure tunable adhesive system of claim 5, wherein the clusters of the asperities each have a shape of a polygon or ring whose interior is free of asperities.

7. The pressure tunable adhesive system of claim 6, wherein the asperities are characterized by a dimensionless parameter, \tilde{δ}=δ(E*/b)^{0.5} of 0.1 to 10, wherein δ is a height of the asperities, b is a radius of the clusters of the asperities, E* is elastic modulus of the elastic adhesive substrate, and W is work of adhesion of the pressure tunable adhesive system.

8. The pressure tunable adhesive system of claim 1, wherein the asperities have spherical upper surfaces and interfaces between the asperities and the surface of the elastic adhesive substrate are flat.

9. A method of forming the pressure tunable adhesive system of claim 1, the method comprising:
providing the elastic adhesive substrate; and
forming the patterns of the asperities on the surface of the elastic adhesive substrate.

10. The method of claim 9, wherein the forming step comprises:
applying a polymer thin film on the surface of the elastic adhesive substrate;
dewetting the polymer thin film to form droplets; and
solidifying the droplets to form the patterns of the asperities.

11. The method of claim 10, wherein the dewetting comprises applying an external thermodynamic driving force to the polymer thin film.

12. The method of claim 11, wherein the external thermodynamic driving force is performed by temperature or solvent annealing of the polymer thin film.

13. The method of claim 10, the method further comprising controlling a thickness of the polymer thin film to control heights of the asperities.

14. A method of using the pressure tunable adhesive system of claim 1, the method comprising using the pressure tunable adhesive system in a pick-and-place material handling process to pick up and place objects.

15. The method of claim 14, further comprising varying a force required to remove from the object from the pressure tunable adhesive system by varying an applied preload used to adhere the object to the pressure tunable adhesive system.
